(19) United States
(12) Patent Application Publication
(10) Pub. No.: US 2026/0290924 A1
(43) Pub. Date: Sep. 24, 2026

(54) IMPROVED FLOODED BATTERY CELLS

(71) Applicant: PHILADELPHIA SCIENTIFIC LLC, Montgomery, PA (US)

(72) Inventors: William E. M. Jones, Freeport (BS); Trevor Alden, Huntington Valley, PA (US)

(21) Appl. No.: 19/474,409

(22) PCT Filed: Apr. 11, 2024
(86) PCT No.: PCT/US2024/024132

§ 371 Date: Oct. 10, 2025

Related U.S. Application Data
(60) Provisional application No. 63/495,397, filed on Apr. 11, 2023.
(60) Provisional application No. 63/510,475, filed on Jun. 27, 2023.

(51) Int. Cl. H01M 10/52; H01M 10/08; H01M 10/12; H01M 10/26; H01M 10/28; H01M 10/30; H01M 10/42; H01M 10/44; H01M 50/392

(52) U.S. Cl. CPC H01M 10/523; H01M 10/08; H01M 10/26; H01M 10/28; H01M 10/30; H01M 10/4242; H01M 10/44; H01M 50/392; H01M 10/121; H01M 2300/0011; H01M 2300/0014

(57) ABSTRACT

Methods for operating a flooded electrolyte battery cell used in standby service to prevent the loss of water. When charging the cell, water in the electrolyte decomposes electrolytically to oxygen and hydrogen gases. The method includes catalytically recombining the oxygen and hydrogen gases to water vapor, inhibiting venting of the oxygen and hydrogen gases and water vapor from the cell, providing fluid communication between the catalyst and the electrolyte for the oxygen and hydrogen gases and water vapor, and hygroscopically absorbing the water vapor into the electrolyte. Devices and battery cells for carrying out the method are also provided.

### CROSS REFERENCE TO RELATED APPLICATIONS

The present application claims the benefit of U.S. provisional applications 63/495397, filed Apr. 11, 2023, and 63/510475, filed Jun. 27, 2023, the contents of which are hereby incorporated by reference in their entireties.

### BACKGROUND

### Field of the Invention

The present invention relates to improvements to flooded battery cells, and more particularly, the use of catalysts to minimize and eliminate watering maintenance in standby flooded cells.

### Background of the Invention

A battery is a device that converts chemical energy into electrical energy through electrochemical reactions. A battery typically consist of two or more cells electrically connected in series to form a single battery unit. Multiple batteries, each with multiple cells, can be connected electrically to one another in series and in parallel to provide the desired amount of electrical output. While the terms “battery” and “cell” are used interchangeably, as the basic unit of a battery, the individual cell is the focus of the discussion below.

Various types of battery cells are known for use in different applications. Exemplary types of battery cells include flooded lead acid battery cells and sealed lead acid battery cells. Exemplary uses of batteries include stationary batteries on standby to provide backup and emergency power should the regular electrical grid fail, and traction batteries for use in motive applications such as for forklifts and other vehicles.

The construction of a traditional flooded battery cell is shown schematically in FIG. 1. It has at least two electrodes or plates: a positive and a negative plate. Each of these plates is made of a current-conducting grid and an energy-storing active material. The plates are immersed in a bath of liquid electrolyte, such as an aqueous solution of dilute sulfuric acid as used in lead acid battery systems. A non-electrically conducting porous separator is positioned between the plates to prevent the plates from contacting one another, preventing electrical short circuiting within the cell, but which is permeable to the electrolyte. The electrolyte and the plates are housed in a liquid tight container having a top cover, and two terminals extending through the cover—a positive terminal and a negative terminal for connecting the cell to the electrical load or system to be powered.

A traditional flooded cell is also vented to the atmosphere through a simple orifice or opening (gas vent) typically provided in the cell cover. The vent provides an uninhibited and continuous opening that allows the exchange of gases between the inside of the cell and the surrounding atmosphere, permitting gases generated within the cell to escape to the surrounding atmosphere. It is common to provide a vent cap (not shown) over the gas vent that has openings to allow the gases to vent freely, but which is configured to receive a watering nozzle for adding water to the cell.

As in any lead acid cell, when being charged, i.e., is “on charge”, the water in the sulfuric acid electrolyte decomposes to oxygen and hydrogen gases through the process of electrolysis. In flooded lead acid cells, these gases escape the cell to the atmosphere through the vent. This electrochemical decomposition of the water and the venting of the resulting hydrogen and oxygen gases causes a loss of water from the electrolyte, lowering the electrolyte level within the cell. Flooded cells can also lose water through evaporation, the vaporized water venting from the cell to the atmosphere and adding to the water loss. The warmer the environment of the cell, the greater the evaporation rate. With such cells, water maintenance is required to replenish the water loss and maintain the proper electrolyte level. This is typically done by the addition of distilled water. Failure to maintain the proper electrolyte level can expose the plates above the electrolyte, which can reduce the electrical output of the cell and shorten the cell's life. Water maintenance programs to monitor the electrolyte levels of the individual cells and add water as needed are costly. As other components of a battery cell do not require maintenance as regularly, water maintenance is one of the major costs for the upkeep of battery systems.

Significant improvements to battery cells have been made to minimize water loss. One improvement is the valve regulated lead acid cell, or “VRLA” cell, a form of a “sealed cell”. These are similar to flooded lead acid cells with some key differences. One difference is that the plates are not immersed in a bath of liquid electrolyte, but are in contact with an immobilized electrolyte (not a bath of liquid), that has pathways allowing gases within the cell to have direct and easy access to the cell plates for minimizing water loss as described below. In one form of a VRLA cell, the plates are sandwiched between sponge like separators that are made usually from an absorbent glass fiber. Most of the electrolyte is absorbed in the separators. This type of VRLA cell is called the “absorptive glass mat” type or AGM cell. Another type of VRLA cell is the “gel cell” in which liquid electrolyte of the type used in a conventional flooded cell is replaced by a gelled electrolyte.

The VRLA cell minimizes water loss by providing for an internal oxygen recombination cycle within the cell, also referred to as the “internal oxygen cycle”, which recombines the oxygen and hydrogen gases to water. As the plates are not immersed in a bath of liquid electrolyte, oxygen and hydrogen gases produced by the decomposition of water can easily migrate or diffuse through the immobilized electrolyte to the plates where the gases are recombined to water through the internal oxygen cycle. The internal oxygen cycle is not generally applicable for the flooded cell as gases cannot readily migrate or diffuse through the bath of electrolyte to the plates, but instead bubble up through the liquid electrolyte and vent from the cell to the atmosphere.

The second key difference between the VRLA cell and a flooded cell is that the VRLA cell is not vented to the atmosphere, but instead has a one-way valve that provides for pressurization of the cell, typically between 2 and 5 psi, to maintain the gases within while having a one-way pressure relief valve to prevent over pressurization that could damage the cell. The one way-valve keeps atmospheric air from entering the cell where the excess oxygen in the air, out of balance with the ratio of oxygen and hydrogen gases normally in the VRLA cell, would have direct access to the plates, causing self-discharge of the negative plate and poisoning of the cell. Atmospheric air entering a flooded cell is not an issue as gases cannot migrate or diffuse through the bath of liquid electrolyte to the plates, although this prevents flooded cells from using the internal oxygen cycle to recombine gases. Furthermore, VRLA cells tend to be smaller and have less capacity to provide continuous power than flooded cells, and thus flooded cells are used much more widely in large standby applications and in critical and high risk applications.

Another improvement is the addition of a catalyst. For the flooded cell, a catalyst device can be attached to the vent such that gases leaving the vent of the cell pass by a catalyst that can recombine a portion of the oxygen and hydrogen gases back to water vapor. This water vapor then condenses to liquid water on the internal walls of the catalyst device and drips back through the vent into the cell. Even in the best of conditions, however, such devices can recombine and condense only a portion of the gases, the remainder of the oxygen and hydrogen gases and the non-condensed water vapor may still exit to the atmosphere. The efficiency of such devices is temperature dependent. The warmer the temperature of the environment in which the cell is located, the lower the condensation rate of the water vapor. Moreover, current recombination devices require sufficient surface area on which the water vapor can condense, making such devices larger than desired. Thus, such devices still allow gases to vent to the atmosphere. Regular water maintenance, even if reduced, is still required.

Another type of condensation catalyst device is disclosed in U.S. Pat. No. 10,960,376 to Strohmenger et al. While this device seeks to increase the retention time of the hydrogen and oxygen gases within the device to maximize the recombination rate to water vapor, it still relies on condensation to form liquid water which then flows downward through the device to the electrolyte, and thus requires a large body to provide sufficient area for the condensation process. Moreover, the efficiency of such a condensation device is still temperature dependent, affecting its ability to handle excess gassing effectively.

One of the most popular uses for battery cells, particularly flooded lead acid cells, is stationary battery service. Such cells are used to provide electrical power only on a standby basis, i.e., the battery cell acts as an emergency power source where the regular power supply has failed for some reason. Battery cells in standby service are kept fully charged so that they can “kick in” immediately without interruption when the regular power supply fails to provide power to the load, the load being the systems and equipment to be powered by the battery cell. Stationary battery cells are infrequently discharged. The cells will provide the backup power until the regular power supply is restored or a separate backup generator starts up and comes on line. Examples of major stationary battery markets include telecom and broadband power backup, uninterruptible power supplies (“UPS”) for computer backup, and utility backup to provide backup power for switches, monitors and communication equipment for electricity generation and transmission systems. As a specific example, nuclear power plants have many flooded cells on standby service to provide backup electrical power to the controls of the power plant should the regular power supply fail.

In stationary applications, the cell is electrically connected to the load in parallel with the regular power supply. If the regular power supply fails, the battery cell discharges to provide electrical power to the load without any interruption. To recharge the cell once the regular power supply is restored, and to maintain the cell at full charge during the potential long periods of time that the cell is on standby, such cells are connected to a charger that provides the electrical power to recharge and maintain the cell at full charge while on standby. The charger is also connected to the regular power supply. Normally, charging continues during the entire time the cell is on standby, ceases when the power supply fails and the cell discharges power to the load, and is restored when the regular power is restored at which time the cell reverts to standby.

There are a number of charging methods for flooded cells used in standby service, most, if not all of which involve “float charging”. Float charging is the application of a constant-voltage applied continuously to the cell during standby. This keeps the cell fully charged and ready to be used on demand without interruption if and when the regular power supply fails. The float charge can be applied to the cell indefinitely while on standby until the next discharge event, at which time the charging ceases with the loss of the regular power supply and the cell discharges to provide power to the load. Once the regular power supply is restored, the charging begins again. Even after the cell is fully charged, a float charge voltage is continuously applied to the cell to maintain the cell at full charge, compensating for losses caused by self-discharge while the cell is on standby.

The float voltage at which the cell float charges is normally slightly in excess of the value of the open-circuit voltage of the cell. The open-circuit voltage for a fully charged lead acid cell is typically about 2 to 2.05 Volts. Open-circuit voltage is the difference of electrical potential between the positive and negative terminals of the cell when disconnected from any circuit.

Various charging methods are known. Some may apply a constant current (amperage) and/or a voltage higher than the float voltage at different stages of the charging process, typically after a discharge vent, but then revert to a float charge to complete and maintain a full charge. For example, to lessen the time to restore the cell to full charge immediately after a cell discharge event, one alternative charging method includes a short time period of charging at a charge voltage higher than the float charge voltage, e.g., 12 to 72 hours, but then reverts to a float charge at the lower float charge voltage applied continuously thereafter until the next discharge event or other event that interferes with the float charging.

While providing a charge to a fully charged cell compensates for losses caused by self-discharge while the cell is on standby, charging a fully charged cell causes electrolytic decomposition of the water in the electrolyte to hydrogen and oxygen gases. Moreover, the higher the charging voltage applied to a fully charged cell, the greater the rate of decomposition. In practice, the selection of charging voltages is a compromise between the optimal charging conditions, such as the time to obtain full charge, and other factors such as the loss of water that will result from too high a charge voltage.

It is during charging, and particularly during the potentially long periods of float charging, when the voltage is in slight excess of the value of the open circuit voltage of the fully charged cell, that much of the electrolytic decomposition of the water to oxygen and hydrogen gases takes place. Accordingly, such cells decompose water to oxygen and hydrogen gases at fairly low rates continuously when being charged. However this constant loss of water, even at a minimal rate, coupled with any evaporation of water from the cell, over long periods of time can lower the electrolyte level significantly, requiring routine water maintenance.

Stationary flooded cells are ideal for standby uses, and hundreds of millions of them are believed to be in service around the world. These cells are operating successfully, but require costly ongoing monitoring and watering maintenance. Moreover, the venting of oxygen and hydrogen gases may be problematic in some uses as these gases can create a risk of fire and explosion if not properly ventilated.

The present invention relates to improvements in the design of and operation of flooded cells.

### SUMMARY OF THE INVENTION

In accordance with the present invention there is provided a method for charging a flooded cell in standby service. The cell includes a positive electrode and a negative electrode in a spaced relationship from one another, and a liquid electrolyte that includes a hygroscopic material in which the positive electrode and the negative electrode are immersed. During charging of the cell, at a charge voltage which has a value in excess of the value of the open-circuit voltage of the fully charged cell, there is electrolytic decomposition of water in the electrolyte to hydrogen and oxygen gases. The invention includes inhibiting the venting of gases from the cell, which gases include hydrogen and oxygen gases and water vapor generated by recombining the hydrogen and oxygen gases; catalytically recombining the oxygen and hydrogen gases to water vapor by use of a catalyst; providing fluid communication between the electrolyte and the catalyst by which said hydrogen and oxygen gases and the catalytically recombined water vapor can flow between the electrolyte and the catalyst; and hygroscopically absorbing a majority of the water vapor into the electrolyte.

In accordance with another aspect of the present invention, there is provided a recombination device attachable to a flooded battery cell. The battery cell includes a liquid electrolyte having a hygroscopic material, a gas space, and a vent opening through which gases can vent from the cell. The recombination device includes a housing providing a leak tight interior when the device is attached to the cell; a catalyst disposed within the leak tight interior, the catalyst capable of combining oxygen and hydrogen gases to form water vapor; a mount for sealingly attaching the device to the vent opening of the battery cell; and wherein the housing has an opening positioned to be in fluid communication with the gas space of the cell through the vent opening when the device is attached to the cell to allow fluid communication between the catalyst and the electrolyte.

In accordance with another aspect of the invention, there is provided an improved flooded aqueous battery cell that includes a container having an opening therein; a liquid electrolyte comprising a hygroscopic material within the container; a gas space in which oxygen and hydrogen gases generated by electrolysis of water from within the cell collects, the cell opening being in fluid communication with the gas space; at least one positive plate immersed in said electrolyte; at least one negative plate immersed in said electrolyte; and a recombination device sealingly closing the cell opening to form a leak tight connection therewith. The recombination device further includes a housing having a leak tight interior; a catalyst disposed within the leak tight interior, the catalyst being capable of combining oxygen and hydrogen gases to form water vapor; and the housing incudes an opening positioned to be in fluid communication with the gas space of the cell through the cell opening to allow fluid communication between the catalyst and the electrolyte.

Other embodiments of the invention are also provided such as a catalyst device usable with the recombination device.

It should be appreciated from the following detailed description of the present invention that the present invention provides methods, devices, and improved cells that overcome the aforementioned type of problems that are associated with the prior art flooded cells.

### BRIEF DESCRIPTION OF THE DRAWINGS

FIG. 1 is a schematic cross-sectional view of a traditional flooded cell;

FIG. 2 is a schematic cross-sectional view of a flooded cell in accordance with the present invention;

FIG. 3 is an elevation view of a recombination device in accordance with the present invention;

FIG. 4 is a cross sectional view of the recombination device of FIG. 3 taken along line 4-4;

FIG. 5 is an exploded perspective view of the recombination device of FIG. 3;

FIG. 6 is an exploded elevational view of the recombination device of FIG. 3;

FIG. 7 is an enlarged perspective view of the cap and top cover shown in FIG. 5;

FIG. 8 is a perspective view of the catalyst device shown in FIGS. 4 and 5;

FIG. 9 is a cross sectional view of the catalyst device of FIG. 8;

FIG. 10 is a partial cross sectional view of the catalyst device of FIGS. 8 and 9 showing the outer side of the end caps;

FIG. 11 is a perspective view of another embodiment of a catalyst device;

FIG. 12 is a cross sectional view of the catalyst device of FIG. 11;

FIG. 13 is an perspective view of an alternative embodiment of a recombination device;

FIG. 14 is an exploded perspective view of the recombination device of FIG. 13;

FIG. 15 is a cross sectional view of the recombination device of FIG. 13;

FIG. 16 is a schematic cross sectional view of a cell with the recombination device of FIG. 3 shown on float charge;

FIG. 17 is a schematic cross sectional view another embodiment of a recombination device;

FIG. 18 is a schematic cross sectional view of yet another embodiment of a recombination device;

FIG. 19 is a schematic cross sectional view of another embodiment of a recombination device; and

FIG. 20 is a schematic diagram illustrating the reaction cycle taking place in a method of the present invention.

### DETAILED DESCRIPTION OF THE INVENTION

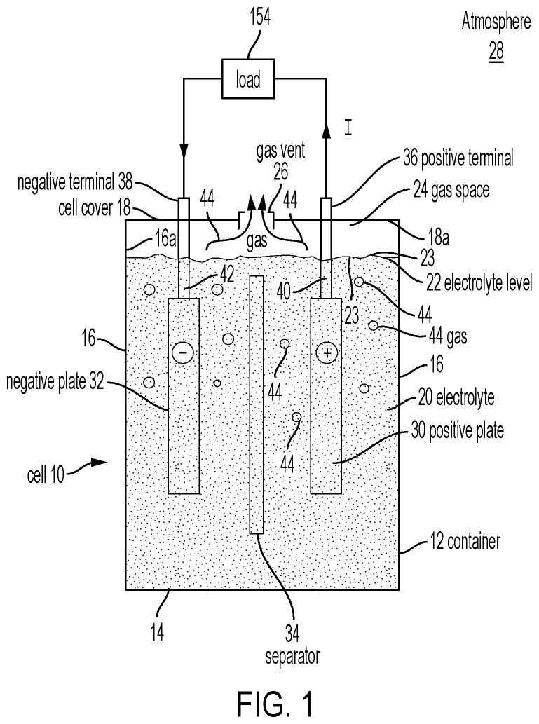

With reference to FIG. 1, a vented flooded cell 10 suitable for use with the present invention has a container 12 having a container bottom 14, side walls 16, and cover 18. Contained within the container 12 is a suitable liquid (flooded) electrolyte 20. The electrolyte 20 has a liquid level 22 defined by a surface 23 of the electrolyte 20. Above the liquid level is a gas space 24 in which oxygen and hydrogen gases generated in the cell 10 collect. The gas space 24 is defined by the electrolyte level 22, the inner surface 16a of the container walls 16, and the inner surface 18a of the container cover 18. A vent opening 26 in the container cover 18 is positioned to allow fluid communication between the gas space 24 and the environment or atmosphere 28 outside the cell 10 as in prior art cells discussed previously.

A positive electrode 30 having an active material is positioned within the container 12 immersed in the electrolyte 20. A negative electrode 32 having an active material is also positioned in the container 12 immersed in the electrolyte 20, and in spaced relationship from the positive electrode 30. Such electrodes 30, 32 are typically in the form of plates, which term will be used synonymously herein with the term electrodes. A porous separator 34 is positioned between the electrodes 30, 32 to prevent the electrodes from contacting one another, but is permeable to allow the electrolyte 20 to pass freely therethrough. As discussed above, the electrodes should preferably remain fully immersed in the electrolyte 20, i.e. fully covered, to avoid potential problems.

The positive and negative electrodes 30 and 32 are connected electrically to respective positive and negative terminals 36 and 38, typically by respective positive and negative straps 40 and 42, as they are commonly referred to in the art.

It is believed that the flooded cells 10 that will be used most widely with the present invention will be of the lead acid type that will include the following: a positive electrode 30 comprising a conductive material such as a lead alloy, and active material comprising lead oxide (PbO₂); a negative electrode 32 comprising lead, preferably finally divided particles of substantially pure lead, referred to in the industry as “sponge lead”; and an aqueous electrolyte 20 of dilute sulfuric acid. However, the present invention described herein is applicable to other flooded battery types that use an aqueous electrolyte, such as Nickel/Cadmium and Nickel/Metal Hydride batteries, both of which use an electrolyte of potassium hydroxide.

The stationary flooded cell 10 in standby service is typically charged on a continuous basis and over a long term, e.g., in excess of five years. The charging ceases when the regular power supply fails, at which time the cell discharges to provide electrical power to the load 154, previously powered by the regular power supply, without any interruption. Once the regular power supply is restored, the continuous charging is restored to recharge and maintain the full charge of the cell 10 until the next time the regular power supply is interrupted. The term “continuous” as used herein in connection with the charging of the cell is intended to mean an uninterrupted flow of current, as well as an intermittent flow of current, for example, a pulsating current, as known in the art in some float charging.

As mentioned above, a stationary flooded cell used for standby power is typically float charged at a voltage having a value that is slightly in excess of the value of the open circuit voltage of the fully charged cell. Without intending to limit the float voltage to a specific voltage, as the float voltage can vary with the design and chemistry of the particular cell as well as the ambient temperature, a typical float charge voltage includes a value up to and including about 0.3 volts above the open circuit voltage of the fully charged cell. Again, a float charge is a constant-voltage charge provided continuously for some time period while the cell is on standby, and can continue for years. Typical float charge voltages for stationary lead acid flooded cells in standby service can range from between and including about 2.08 and 2.38 volts, with a preferred range between and including between about 2.23 and 2.27 volts, and a more preferred float charge voltage of about 2.25 volts.

Again, as mentioned above, during the periods of float charging, when the voltage is in slight excess of the value of the open circuit voltage of the fully charged cell, the electrolytic decomposition of the water in the electrolyte 20 to oxygen and hydrogen gases 44 takes place. The gases 44 bubble up through the electrolyte 20 to the gas space 24 and, in a traditional prior art cell, would normally exit the cell 10 to the surrounding atmosphere 28 through the vent 26 as seen in FIG. 1. Although such cells decompose water to oxygen and hydrogen gases at fairly low rates, this constant loss of water, even if minimal, coupled with the evaporation of water from the cell 10, over long periods of time lower the electrolyte level 22 significantly. Routine water maintenance is required to avoid exposing the plates 30, 32 above the electrolyte 20.

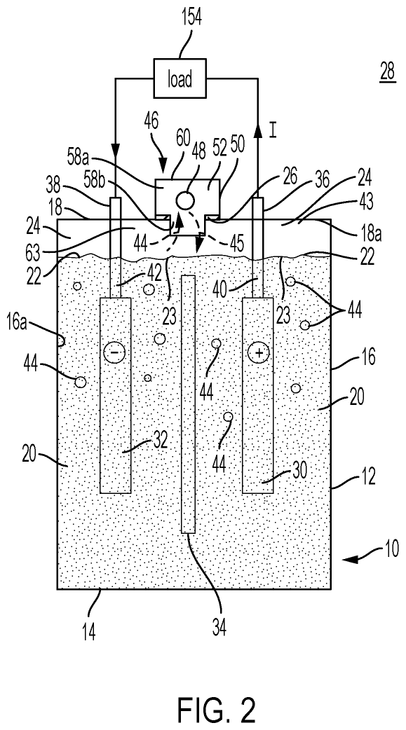

To address the problem of the loss of water from the cell 10, and avoid the maintenance costs and potential damage to the cell 10 associated with the loss of water, the present invention provides a means for preventing the loss of most if not all of the water that would normally be lost from the cell 10. This is described initially with further reference to FIG. 2, showing a cell 10 similar to that shown in FIG. 1 and with like elements referenced with like reference numbers. Such means for preventing the water loss includes a catalyst 48 in fluid communication with the gas space 24 of the cell 10 for recombining the hydrogen and oxygen gases 44 to water vapor 45. Unless otherwise indicated, the phrase “fluid communication” as used herein is intended to mean the uninhibited and unrestricted flow of gases between two or more objects and/or areas.

The catalyst 48 is preferably provided or mounted in a recombination device 46 that attaches to the gas vent 26 as further described below. The recombination device 46, in addition to containing the catalyst 48, inhibits the venting of the oxygen and hydrogen gases 44 and water vapor 45 from the cell 10, and also inhibits the ingress of atmospheric gases 28 into the cell 10 through the vent 26. The term “inhibit” as used herein in regard to the venting or ingress of gases means the prevention of the venting and ingress of gases from and into the cell 10 under normal operating conditions. The oxygen and hydrogen gases 44 flow up to the catalyst 48 where they are recombined to water vapor 45, and then the recombined water vapor, and any water vapor from evaporation, is hygroscopically absorbed by the electrolyte 20 in view of the hygroscopic nature of the electrolyte 20, particularly with sulfuric acid electrolyte, which is highly hygroscopic.

Hygroscopy is a phenomenon that attracts and absorbs water vapor from the environment surrounding the liquid electrolyte 20 (e.g., the cell gas space 24) directly into the electrolyte. This restores the water lost to electrolytic decomposition and thereby maintains the volume of the electrolyte 20.

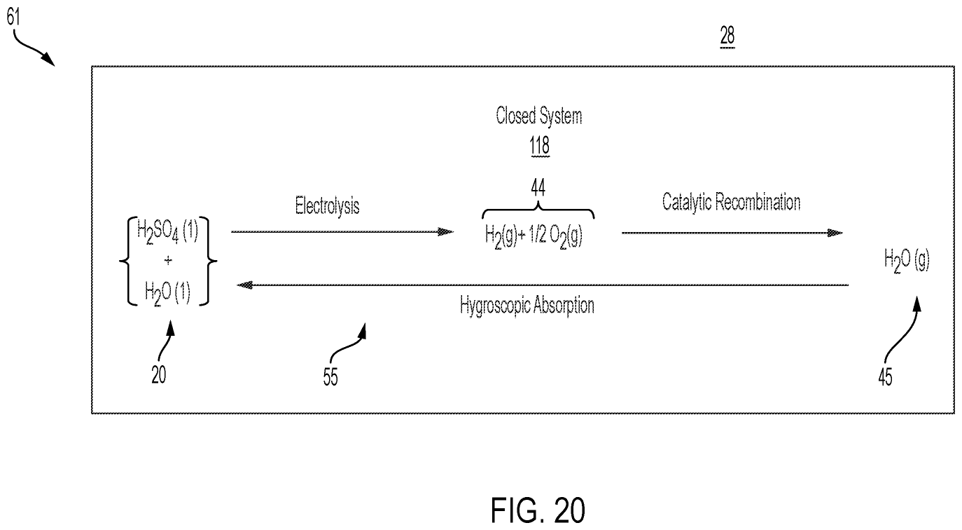

As mentioned above, the charging of the cell 10 electrolytically decomposes the liquid water in the electrolyte 20 to oxygen and hydrogen gases 44 through the process of electrolysis. The reaction can be shown as H₂O(l)→H₂(g)+½O₂(g). The addition of the recombination device 46 over the vent opening 26 creates a closed system 118 that inhibits the cell gasses 44, 45 from exiting the system 118 and the atmospheric/environment gases 28 from entering the system 118 under normal operating conditions. (The cell container 12, other than the vent opening 26, is leak tight). This closed system 118 includes the electrolyte 20, the gas space 24, and the catalyst 48. Accordingly, within this enclosed system, the decomposed gases 44 are recombined to water vapor 45 by the catalyst 48, which reaction can be shown as H₂(g)+½O₂(g)→H₂O (g), and which water vapor 45 is then hygroscopically absorbed into the electrolyte 20 as shown schematically in FIG. 20, restoring the liquid water that was decomposed. Within the closed system 118, the electrolyte 20 and the catalyst 48 are in fluid communication with one another so that the gases 44 and water vapor 45 can flow therebetween, i.e., the oxygen and hydrogen gases 44 exiting the electrolyte 20 can flow to the catalyst 48 for recombination to water vapor 45, and the recombined water vapor 45 can flow to the electrolyte 20 for hygroscopic absorption, uninhibited and unrestricted (minimum head loss) as previously noted.

With continued reference to FIG. 20, it is believed that the present invention provides an internal recombination/hygroscopic cycle 55 operating within the closed system 118. While the cell 10 is on float charge, this is a continuous cycle, i.e., water from the electrolyte 20 is continuously decomposed to oxygen and hydrogen gases 44, and these gases are continuously recombined to water vapor 45 and then returned to the electrolyte 20 through hygroscopic absorption. Under normal operating conditions, this cycle can provide a maintenance free flooded battery cell-one that loses virtually no water over long periods of time. During the very infrequent times that such cell 10 is discharging electrical power i.e., when the regular power supply is down, the cell is not being charged and therefore gas generation is minimal. Further description of this cycle with reference to FIG. 20 is provided below.

It is appreciated that the embodiment of the invention as so far described is a traditional flooded vented cell 10 with the addition of a recombination device 46. Accordingly, as will be understood with the further description below, this initial exemplary embodiment of the present embodiment can be applied to retrofitting exiting prior art flooded cells currently in service as well as newly produced traditional cells and newly produced cells configured to incorporate the devices and methods of the current invention.

As the present invention provides a means to recombine the oxygen and hydrogen gases generated within the cell, and mitigate if not eliminate water loss, the present invention may make it possible to increase the float voltage on a flooded cell beyond that which would normally be provided. The higher voltage, leading to higher gassing rates, is easily handled by the present invention as demonstrated in tests described further below.

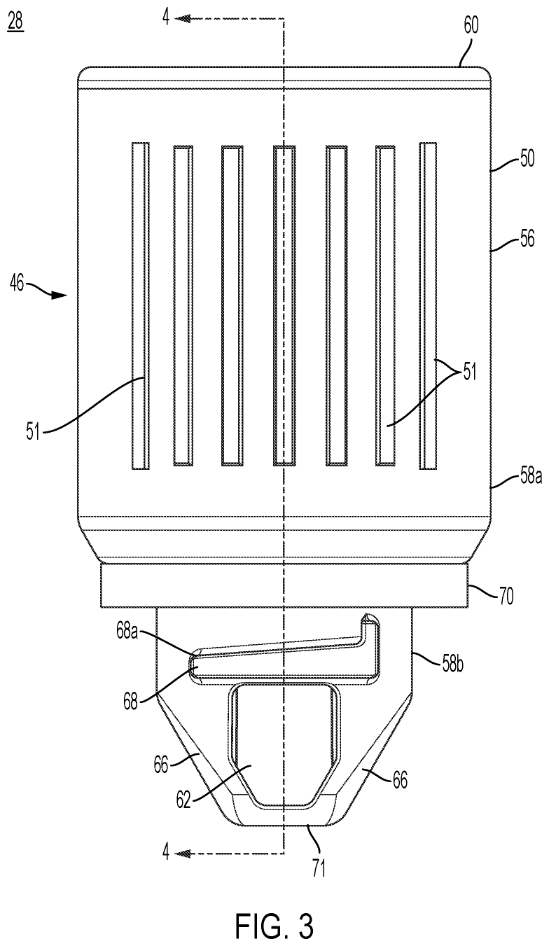

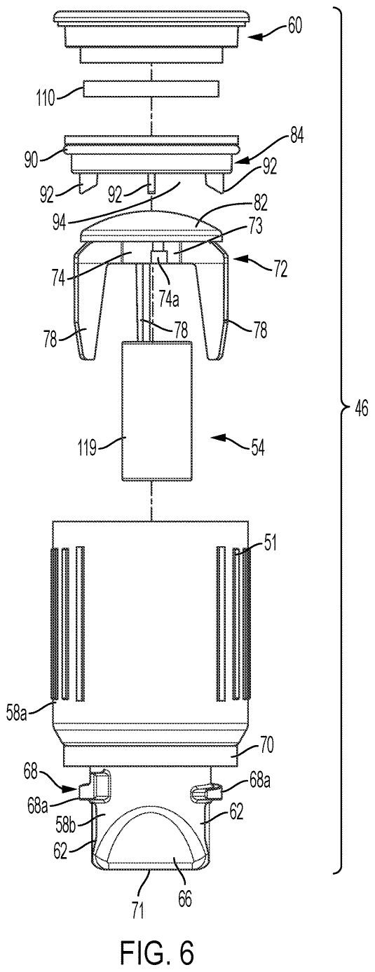

A preferred example of a recombination device 46 in accordance with the present invention is now described with reference to FIG. 2 and with further reference to FIGS. 3, 4, 5, 6 and 7. Again, the battery cell 10 shown in FIG. 2 is identical to that of FIG. 1, but with the addition of a recombination device 46 attached to the cell 10 in the vent opening 26. The recombination device 46 houses the catalyst 48 for recombining the hydrogen and oxygen gases 44, inhibits the venting of gases (the oxygen and hydrogen gases 44 and water vapor 45), inhibits the ingress of atmospheric gases 28, and maintains fluid communication between the electrolyte 20, the gas space 24, and the catalyst 48. The recombination device 46, attached to the cell 10, sealingly closes off the interior 43 of the cell (electrolyte 20, gas space 24, etc.) from the atmosphere 28 and creates the closed system 118 within which the continuous cycle 55 takes place (see FIG. 20).

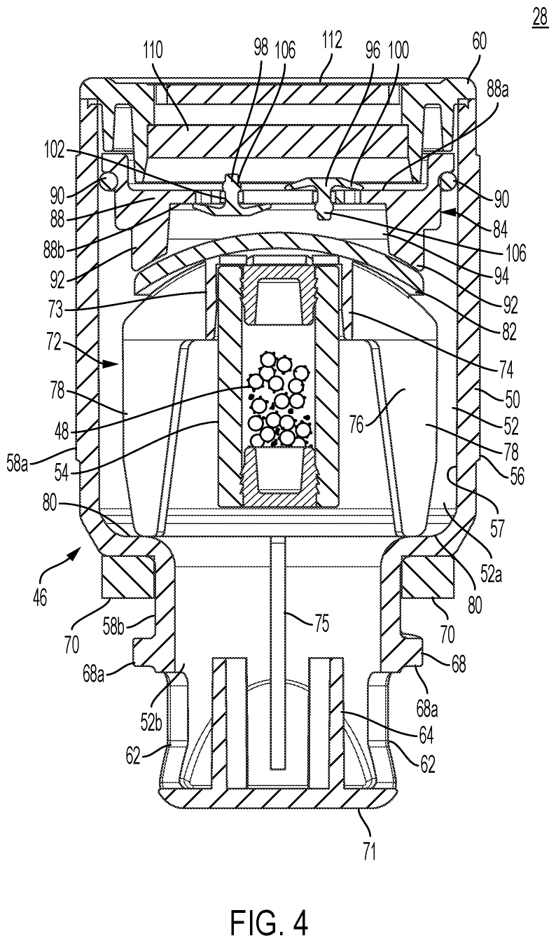

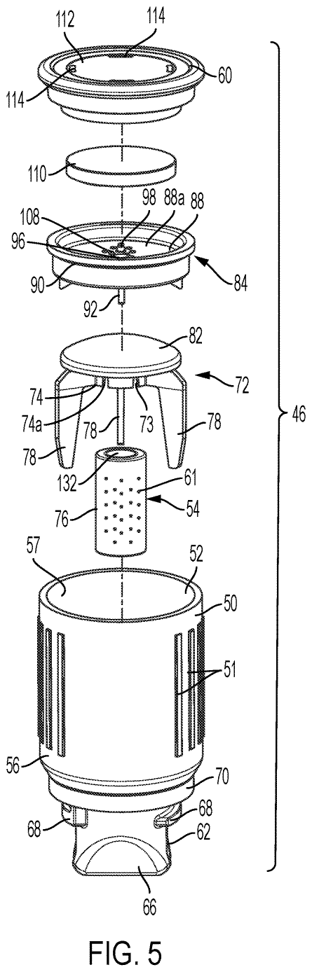

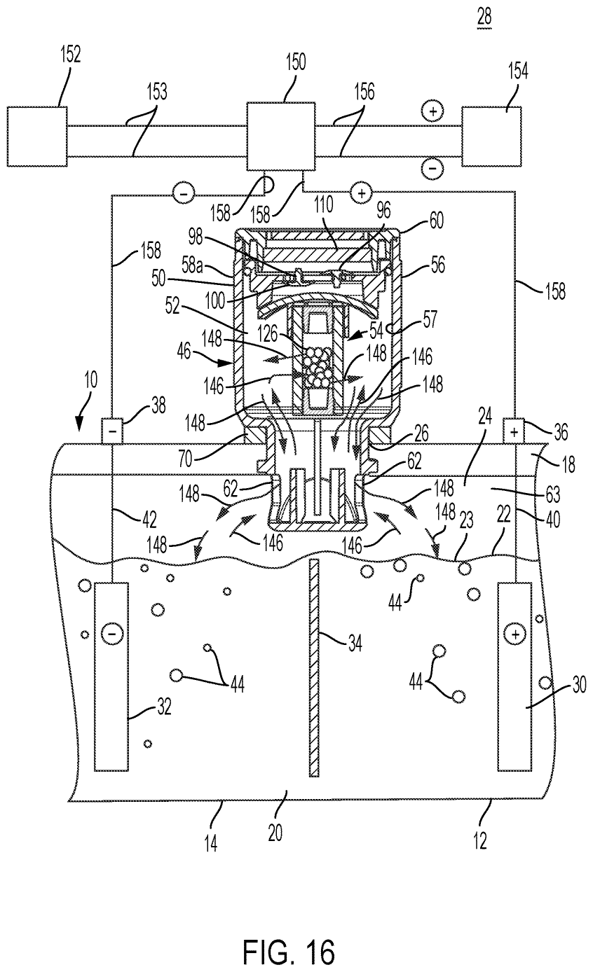

The recombination device 46 has a housing 50 defining an interior 52 (also referred to herein as an internal area 52) that contains a catalyst device 54 (see FIGS. 4, 5). The housing 50 is preferably cylindrical in shape and has an outer wall 56, an inner wall 57, a cylindrical upper section 58a, a cylindrical lower section 58b having a smaller diameter than the upper section 58a, and a top cover 60 attached to and forming the top of the recombination device 46. In this preferred embodiment, recombination device 46 attaches to the cell 10 at the vent opening 26 (see FIG. 16). The lower section 58b extends through the vent opening 26 into the gas space 24, and the upper section 58a extends outside and above the cell 10. Ribs 51 can be provided on the outside of the housing 50 for ease of handling. The recombination device 46 provides a leak (gas) tight interior 52 that sealingly connects to the cell 10 to inhibit the various gases 44 and 45 from venting to the atmosphere and the ingress of atmospheric gases 28 into the cell, and which in combination with the cell 10 creates an enclosed internal area 63 that includes the electrolyte 20, cell gas space 24, and the interior 52 of the recombination device 46. The internal recombination/hygroscopic cycle 55 operates within this enclosed internal area 63, which also forms the closed system 118 as seen in FIG. 20. The recombination device 46 is now described in further detail.

The lower section 58b, also referred to as the mount section, defines a lower internal area 52b, and has an opening 62 in the housing 50, which here is formed as a pair of openings 62 on opposite sides of the housing 50. The opening 62 is sized to allow fluid communication of gases between the device 46 and the gas space 24, and to allow any condensed water to flow back to the cell 10. Internal splash shields 64 along the inside of the housing 50 are spaced from and face each of the openings 62 to protect the catalyst from electrolyte 20 that may splash through the openings 62, such as when the cell 10 is being moved. A mount 68 attaches the recombination device 46 to the vent opening 26. The mount 68 illustrated is a bayonet mount having two arms 68a, which is a common mount used in the U.S. and Europe with cell vent openings. A resilient gasket or O-ring 70, made of a suitable material such as EPDM, works with the mount 68 as known in the art to provide a leak tight connection between the cell 10 and recombination device 46. The lower section 58b of the housing wall includes a solid angled section 66 that directs any liquids within towards the slotted openings 62 for exiting the recombination device 46. A solid bottom section 71 of the housing prevents electrolyte from splashing directly into the recombination device 46. The housing 50 is made of any suitable material such as a flame retardant high-temperature polymer. One exemplary material is XAREC® with a 30% glass impregnated filler.

The opening 62 is sized and configured to allow fluid communication between the device 46 and the cell gas space 24. This allows oxygen and hydrogen gases 44 generated by the electrolytic decomposition of the water in the electrolyte 20 to flow to the catalyst 48, and water vapor 45 generated by the catalyst 48 to flow to the electrolyte 20 where it is hygroscopically absorbed. The opening 62 (or the multiple openings 62 if more than one) should be positioned above the electrolyte 20, preferably in the gas space 24, to allow uninhibited and unrestricted flow of oxygen and hydrogen gases to the catalyst 48, and uninhibited and unrestricted flow of the water vapor from the catalyst 48 to the entire surface area 23 of the electrolyte 20, or as much of the surface area 23 as possible. It is believed that the larger the electrolyte surface area 23 in fluid communication with the water vapor from the recombination device 46, the greater the attraction of the water vapor to the electrolyte 20 and thus the greater the rate of absorption into the electrolyte that is possible. As further described below, this flow of gases allows the oxygen and hydrogen gases from the electrolyte 20 to quickly and easily reach the catalyst 48 for recombination to water vapor, and allows the recombined water vapor to quickly and easily be hygroscopically absorbed into the electrolyte 20 at least at the same rate that the water vapor is generated. In one preferred form, the opening 62, or all of multiple openings 62, should have a total area of at least about 0.2 square inches, the illustrated embodiment having a combined total opening 62 area of about 0.3 to 0.32 square inches.

The internal area 52b of the lower section 58b opens to the internal area 52a of the upper section 58a in which the cylindrical catalyst device 54, containing the catalyst 48, is housed. This is an exemplary catalyst device 54 for the catalyst 48 and is described in further detail below. This internal area 52a is also referred to herein as the catalyst chamber 52a. Preferably, the opening between the internal areas 52a and 52b should be as large as possible, using as much of the vent opening 26 as possible, or at least sized not to inhibit or restrict the flow of gases 44, 45 between the two sections to permit fluid communication therebetween.

A support bracket 72 holds the catalyst device 54 in place. It includes a catalyst device support member 73 that includes a cylindrical wall 74 forming a cup like shape having an internal diameter selected to receive and friction fit with the outer wall 76 of the catalyst device 54. The cylindrical wall 74 includes at least one slot 74a to provide sufficient resiliency to hold the catalyst device 54 securely in place, the preferred embodiment having three slots 74a positioned equally distanced from one another around the wall 74. The support bracket 72 further includes three legs 78 that rest on a lower internal shoulder 80 of the device housing 50 where the upper and lower housing sections 58a, 58b meet, and a conical shaped head 82 that allows any water vapor condensate thereon to drain away from the catalyst device 54 and down towards the openings 62. As seen in the figures, the catalyst device 54 is supported in the housing internal area 52 in fluid communication between it and the openings 62. The support bracket 72 can be made of any material suitable for the environment within the catalyst device 54, including a preferred material XAREC® with a 30% glass impregnated filler. One or more support ribs 75 can be provided along the inner wall 57 of the housing lower section 58b to support the bottom of the catalyst device 54 and prevent it from falling out of catalyst device support member 73.

Positioned above the support bracket 72 is a cap 84 that sealingly closes the upper end of the internal area 52 of the recombination device 46 to make it leak tight. This prevents gases from the cell 10 from flowing through the recombination device 46 to the atmosphere 28, and thereby inhibits the venting of gases from the cell 10. The cap 84 also prevents any gases from the atmosphere 28 from flowing through the recombination device 46 to the cell. A top shelf 88 having a substantially flat top surface 88a and a substantially flat lower surface 88b separate and close off the internal area 52 of the recombination device 46 from the atmosphere 28. An O-ring 90 is positioned between the outer circular surface of the cap 84 and the inner wall surface 57 of the housing 50 to create the leak tight seal. The O-ring 90 is preferably made of a resilient material suitable for the acidic environment of the cell 10, such as EPDM rubber material. The cap 84 also has legs 92 resting on the support bracket 72 and providing a space 94 between it and the support bracket 72. The cap 84 can be made of any suitable material such as XAREC® with a 30% glass impregnated filler.

A pressure relief valve 96 protects the cell 10 from over pressurization. An under pressure or vacuum relief valve 98 protects the cell 10 from a vacuum. Current flooded cells allow uninhibited gas flow in and out of the cell 10 and thus pressure within such cells will be the same as that of the surrounding atmosphere 28, which is 0 psi relative to the surrounding atmosphere (unless otherwise indicated, all pressures provided herein are relative to the surrounding atmosphere 28). Containers 12 of existing traditional flooded cells are not designed to handle more than minor over and under pressurizations as compared with atmospheric pressure, with each battery manufacturer having its own specifications. Accordingly, the relief valves 96 and 98 are provided for safety purposes to protect the cell 10 from pressure incidents during unintended cell behavior that could damage the cell 10 or even lead to an explosion in the case of excess gassing.

Any type of pressure relief valve suitable for use in battery cells can be used, such as those currently used in VRLA cells. One exemplary type of pressure relief valve is illustrated herein. Both relief valves 96 and 98 of the illustrated embodiment are formed of a resilient material that deforms under pressure to allow gases to pass. With specific reference to FIGS. 4, 5 and 7, each relief valve 96, 98 includes a disc shaped head 100, a shaft 102 extending from the disc shaped head 100 through an opening 104 in the shelf 88, and a shoulder 106 bulging from the shaft 102 to maintain the disc shaped head 100 in place urged against the shelf 88.

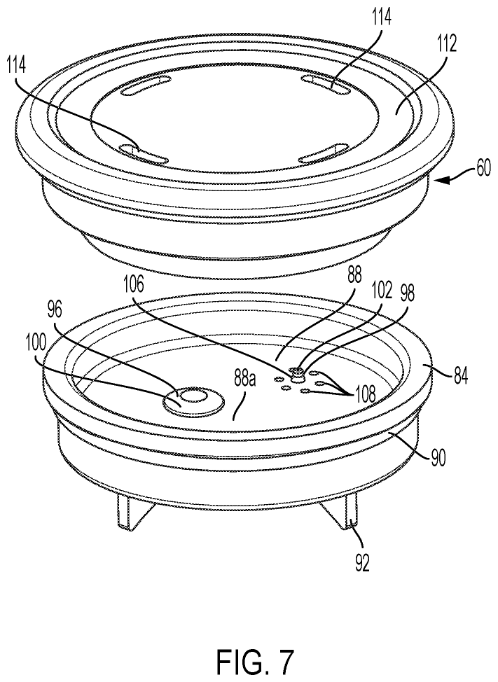

With reference to the pressure relieve valve 96, it is oriented with its disc shaped head 100 on the upper side of the shelf 88 as seen in FIGS. 4, 7, and 16 to cover small openings 108 extending through the shelf 88 (not shown in FIG. 7 as the openings 108 associated with the pressure relief valve 96 are below the head 100, but see the openings 108 for vacuum relief valve 98 in FIG. 7 which are the same), and its shoulder 106 is against the lower side of the shelf 88 as seen in FIGS. 4 and 16. The disc shaped head 100 covers the openings 108 and tapers towards its outer edge to allow sufficient flexibility to deform upwardly and uncover the openings 108 in response to pressure exerted on the underside of the disc shaped head 100 through the openings 108. The vacuum relief valve 98 acts similarly, but is oriented in the opposite configuration as the pressure relief valve 96 opens when a vacuum develops within the cell 10 due to the higher atmospheric pressure acting from above through the openings 108 on the disc shaped head 100 to allow gas from the atmosphere 28 into the cell 10 and relieve the vacuum. The pressure and vacuum relief valves 96 and 98 of the illustrated embodiment are preferably made of a suitable resilient material such as Viton or high temperature silicone, which can be configured for the desired flexibility to activate to open at a pressure selected for the desired use. Such relief valves are known in the art and alternative configurations can be used to provide the desired pressure and vacuum relief.

The pressure relief valve 96 is configured to activate (open) at a selected pressure, plus or minus some tolerance. This pressure will control the maximum pressure within the cell 10. For the pressure relief valve 96, the pressure selected should be sufficient to inhibit the venting of gases to the atmosphere from the cell 10, but low enough to protect the cell 10 from damage due to over pressurization. It has been found that the pressure needed to inhibit the venting of gases is much lower than that which would damage a typical flooded cell 10. In general, it is believed preferable to select a pressure for activating the pressure relief valve 96 that is as minimal as possible. A preferred range of pressure within the cell 10 at which the pressure relief valve 96 will activate is from an amount greater than 0 psi to and including about 1 psi relative to the atmosphere, with a preferred specific pressure goal of about 0.1 psi relative to the atmosphere. The pressure selected could go as high as the pressure that a specific cell 10 could handle without damage, although this pressure is different for the cells of each manufacturer. Again, the goal is not pressurization of the cell 10, but to inhibit venting of the gases from the cell to the atmosphere so that the gases can be recombined to water vapor, while protecting the cell 10 from damage due to over pressurization should such an event occur. In practice, this may require a minimal pressure controlled by the pressure relief valve 96. It is also believed that the highly hygroscopic electrolyte 20, having a high affinity for the water vapor produced from the recombined gases will, under normal operating conditions within the cell 10, absorb the water vapor at a high enough rate to maintain the cell pressure at a minimum. For vacuum relief protection, a vacuum relief valve should preferably open at a pressure of −0.1 psi or higher vacuum. Pressure relief valves 96 and 98 of the type discussed above are known in the art and can be obtained for the desired activation pressure.

The circular top cover 60 forms the top of the housing 50. It is attached preferably to the main housing section by ultrasonic welding. A disk shaped flame arrestor 110 (see FIGS. 4, 5 and 6) formed of a micro-porous disc allows gas to pass through, but prevents a flame from passing through as known in the art. The flame arrestor 110 is snap or friction fitted to the bottom of the cover 60 as shown. All gases exiting or entering recombination device 46, when one of the pressure or vacuum relief valves 96, 98 open, will flow through the flame arrestor 110 to prevent any flame outside of the cell 10 from entering the cell. This is a safety feature as oxygen and hydrogen gases are explosive. Any suitable material such as polypropylene can be used. The top cover 60 has a top section 112 with vent openings 114 to complete the housing 50. The cover 60 can be made of a material similar to that of the housing 50, in this case XAREC® with a 30% glass impregnated filler.

A preferred catalyst device 54 is now described in further detail with reference FIGS. 4, 5 and 8 through 10. The catalyst device 54 includes a catalyst container 119, formed as a cylindrical tube 120, having a micro-porous wall 122 and preferably formed from a hydrophobic material. Positioned within an internal area 124 of the container 119 is the catalyst 48 provided on spheres or beads 126. A filter material 128 can optionally be provided within the container 119 as well. In the illustrated embodiment, it is seen that the catalyst 48 and filter material 128 are not packed tightly within the tube 120, leaving a space 142 within the tube as further discussed below. The tube 120 has openings 129 at both tube ends 130a, 130b closed by plugs 132, These are now described in further detail.

The tube 120 is preferably cylindrical, having a cylindrical wall 122 made of a micro-porous material such as PTFE (e.g., TEFLON®). Other suitable materials can be used, such as porous ceramic material—e.g., a porous ceramic tube or cup as further described below as another preferred embodiment. The tube 120 is preferably hydrophobic to repel water and electrolyte from entering or closing the micro-pores through the tube wall 122. The tube 120 has a length, wall thickness t and a porosity selected for the desired gas flow rates into the internal area 124 for recombination by the catalyst 48. The combination of wall thickness t and porosity of the tube 110 can be selected to handle the expected gas flow rates passing therethrough. It is desirable to allow for a sufficient gas flow rate to keep up with the rate of gassing from the water decomposition in the cell 10. Too low of an allowed gas rate through the wall 122 may cause a buildup of gases in the cell 10, with a corresponding increase of internal cell pressure that could cause the loss of gases through the pressure relief valve 96. It is believed preferable to have a thinner wall thickness t with a lower porosity for a desired flow rate as compared to a thicker wall thickness t with a higher porosity seeking the same flow rate. Experience has shown that the thicker wall with a higher porosity is harder to control to obtain the desired flow rates. Preferable wall configurations include a porous PTFE tube length of 1 inch having a wall thickness of ⅛ inch, outer diameter of 0.5 inch, and average pore size of 10-20 micron, suitable to allow gases to pass through while able to quench a hydrogen-oxygen flame. It is further understood that the length of the tube for any give configuration of thickness and porosity can be selected to obtain a desired flow rate of gases into the device 46, with a corresponding change in the amount of catalyst within the tube 120 for recombining the oxygen and hydrogen gases to water vapor. Accordingly, depending on the application, the catalyst tube 120 can be of any length and/or diameter.

In the illustrated embodiment, the cylindrical tube plugs 132 closing the openings 129 at the ends 130a, 130b are made of a suitable solid material such as a high-temperature polymer suitable for battery environments. One suitable material is XAREC® with a 30% glass impregnated filler. As XAREC® does not readily weld to the PTFE material of the tube 120, a friction fit between the two is preferred. Here, teeth projections 136 are provided on the side wall of the plugs 132. XAREC® is a harder material than PTFE, and as the plugs 132 are pushed into the openings 129 at the tube ends 130a, 130b, the teeth 136 “dig” or penetrate into the softer tube wall 122 to create the friction fit to sealingly close the openings 129.

The catalyst 48 is arranged within the tube 120. Precious metal catalyst such as powdered palladium and platinum are preferred, provided on a suitable substrate 126 such as the ceramic spheres or beads 126 shown. Any suitable material can be used such as the ceramic silica. For the illustrated catalyst 48 provided on a substrate bead 126, the catalyst 48 is coated onto the substrate bead 126 with a suitable adhesive, or otherwise provided on the surface of the substrate.

Consideration is to be given to the size of the substrate 126. Ceramic materials such as silica have a higher thermal mass than many other suitable substrate materials, and a larger bead of silica as compared to a smaller bead of silica can absorb, store and release more heat, potentially increasing in temperature sufficiently to damage materials such as PTFE, a preferred material for the tube 120. This is a possibility during a high rate of gassing, particularly where the beads 126 are in contact with the inner wall 140 of the tube 120. To avoid this problem, smaller ceramic beads 126, e.g., microbeads, are preferred for supporting the catalyst 48. Because of their smaller thermal mass, they will not rise as high in temperature. In one preferred form, the catalyst 48 can be a powdered palladium attached to silica bead substrates within the size range of and including 400 to 600 microns, the palladium being a relatively small percentage by weight of the catalyst/bead unit, e.g., about 0.3 to 1 percent by weight of the catalyst/bead unit, a more preferred range being from about 0.3 to 0.5 percent by weight of the catalyst/bead unit.

The minimum amount of catalyst 48 provided should be sufficient to recombine the expected rate of gas generated by the decomposition of water under normal cell operating conditions. To little catalyst that is insufficient to handle the rate of gas decomposition will lead to pressurization of the cell 10 and gas venting, causing a loss of water. In practice, it is preferable to oversize the amount of catalyst rather than undersize. For most applications, an amount of catalyst 48 sufficient to recombine the amount of gas produced by 5 amps of charging current at any given time is preferred.

Poison filters 128 can be provided within the tube 120 to remove materials from the gases that would prevent the catalyst from working. For example, it is common to add alloys to the lead plates of the cell to improve their strength. One of the most common alloyed metals is antimony. During cell operations, however, the antimony can form stibine gas (SbH₃) that can negatively affect the catalyst. A preferred poison filter material is potassium hydroxide (KOH) provided on a carbon substrate. In the present embodiment, a poison filter material 128 of KOH is provided on a carbon substrate intermixed with the beads 126 of catalyst 48. In one preferred form, the filter material 128 is an activated carbon produced from carbonaceous source materials such as bamboo, coconut husk, corn husk, willow peat, wood, coir, lignite, coal, and petroleum pitch soaked in a solution of KOH. The activated carbon is preferably sized at +12×30 mesh or larger. This minimum size avoids the smaller particles and powders that can block gas flow when wet.

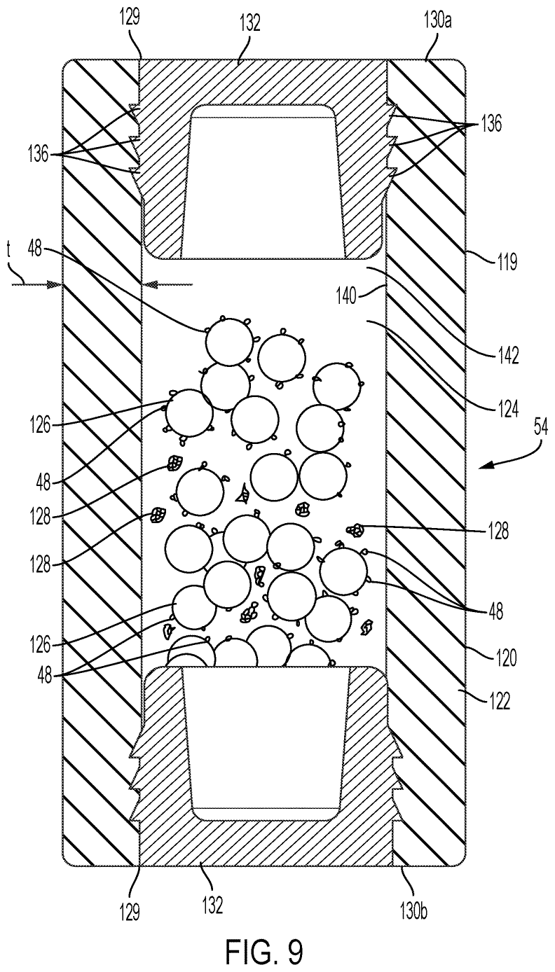

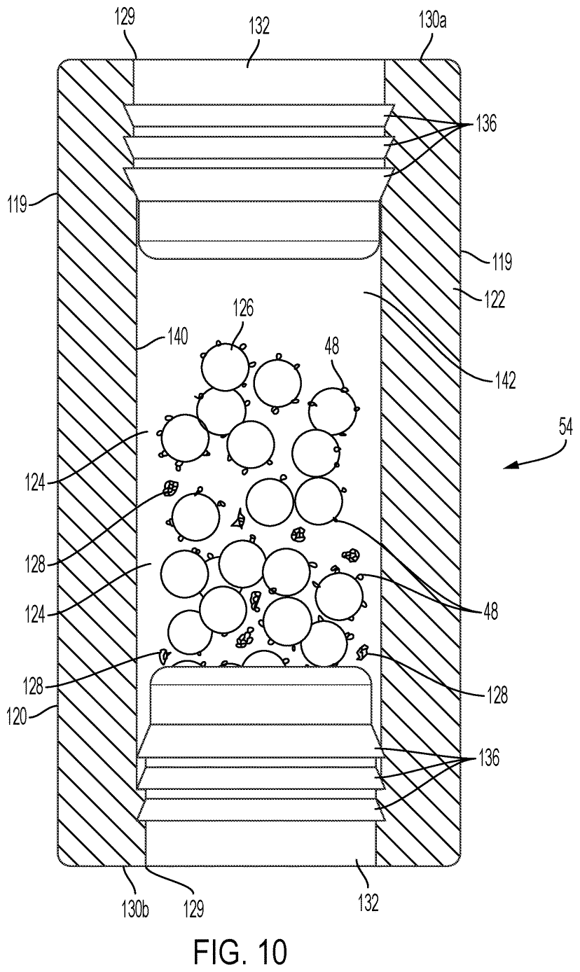

With specific reference to FIGS. 9 and 10, where a filter 128 is provided, it is preferable to provide the catalyst beads 126 and filter material 128 intermixed together. It is also preferable in this embodiment not to tightly pack the filter and catalyst together within the tube 120, but provide the space 142 within to help maintain the filter and catalyst beads in a loose mixed form. As gases can enter the tube 120 through the cylindrical wall from any direction, the intermixing of the catalyst with the filter material helps keep the filter material dry, which filter material can absorb water that condenses from the vapor. The heat generated by the catalyst 48 during the recombination reaction helps keep the filter material dry. Moreover, it is preferable to provide gas recombination and the resulting heat throughout the internal area 124 of the tube 120 to prevent condensation of the water vapor within it, which again could interfere with the flow of gases through the filter material 128 to the catalyst 48.

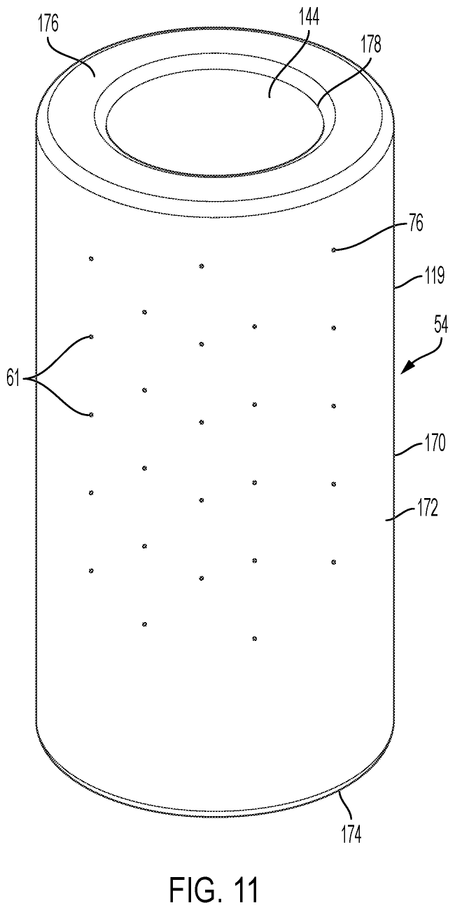

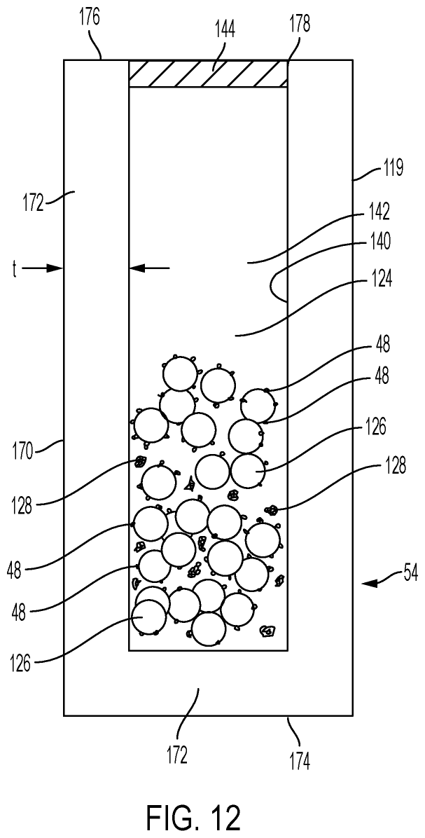

An alternative preferred embodiment of a catalyst device 54 is now described with reference to FIGS. 11 and 12. This embodiment is suitable for use with the same recombination device 46 previously described above.

In this embodiment, the catalyst device container 119 is formed from a porous ceramic material, such as 99 percent alumina. The porous ceramic alumina is formed in the shape of a can 170 having a porous cylindrical wall 172, a porous closed end 174 formed integrally with the porous cylindrical wall 172, and an open end 176 having an opening 178. The opening 178 is sealed closed by a ceramic putty 144 that bonds to the internal walls 140 of the can 170. About a ⅛ inch thick layer of putty 144 is believed to be sufficient. Alternatively, a non-porous plug 132 similar to that discussed above with reference to FIGS. 9 and 10 could be used. Positioned within the internal area 124 of the container 119 is the catalyst 48 provided on spheres or beads 126 and can include filter material 128, both as previously discussed above. The catalyst 48, catalyst beads 126, filter material 128 and configuration of these within the container 119 are similar to that of FIGS. 9 and 10 with like elements being identified with like reference numbers. As a ceramic material may be hydrophilic, such a catalyst device should preferably be shielded or positioned away from the electrolyte 20. See, for example, the above discussion with reference to the splash shields 64 as seen in FIG. 4.

The can 170 has a length, wall thickness t and a porosity selected for the desired gas flow rates into the internal area 124 for recombination by the catalyst 48. As noted previously, the combination of wall thickness t and porosity of the container 119 material can be selected for the desired gas flow rates into and out of the catalyst device 54. It is desirable to provide for a gas flow rate that at minimum can handle the expected rate of gassing due to the decomposition of water in the cell 10 during normal operation, and preferable to provide for a greater amount of gassing to ensure that the normal and unexpected gassing events can be handled to avoid losing water. The pores of the ceramic walls 172 are preferably no larger than the maximum size required to quench a hydrogen-oxygen flame, i.e., to prevent a flame from passing through. This is believed to be a pore size of about 100 microns in diameter. In practice, however, the pores can be much smaller and still sized to handle the rate of gassing expected and more. Ceramic materials such as silica are stronger than PTFE and therefore can have a smaller wall thickness t, thereby allowing a lower porosity for a desired gas flow rate as compared to PTFE. A preferable configuration for a porous ceramic silica can 170 has a length of about 23 mm, a wall outer diameter of about 11.5 mm, a wall internal diameter of about 7 mm, and average pore size of about 20 micron. This embodiment also has the additional porous wall area at the closed end 174 through which gases can flow. The closed end 174, preferably oriented to be on the bottom in the recombination device 46 so that the porous end is closer to the electrolyte, would have a similar wall thickness as that of the wall 152, of about 4.5 mm.

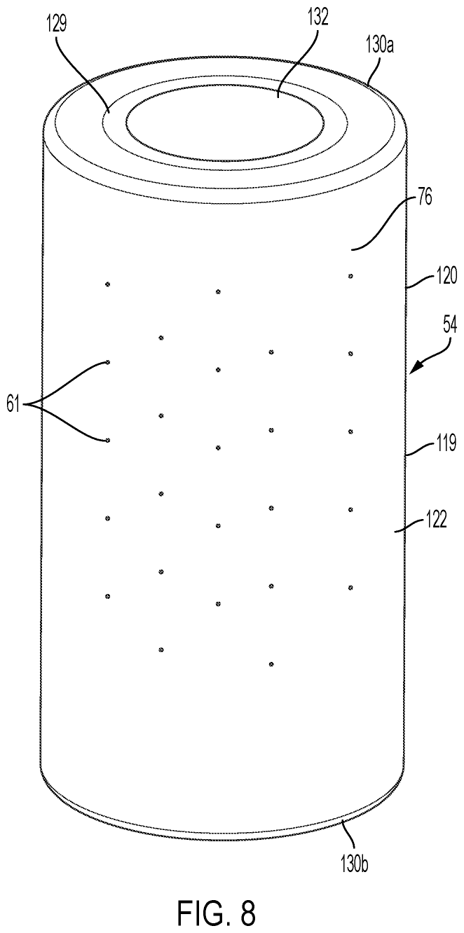

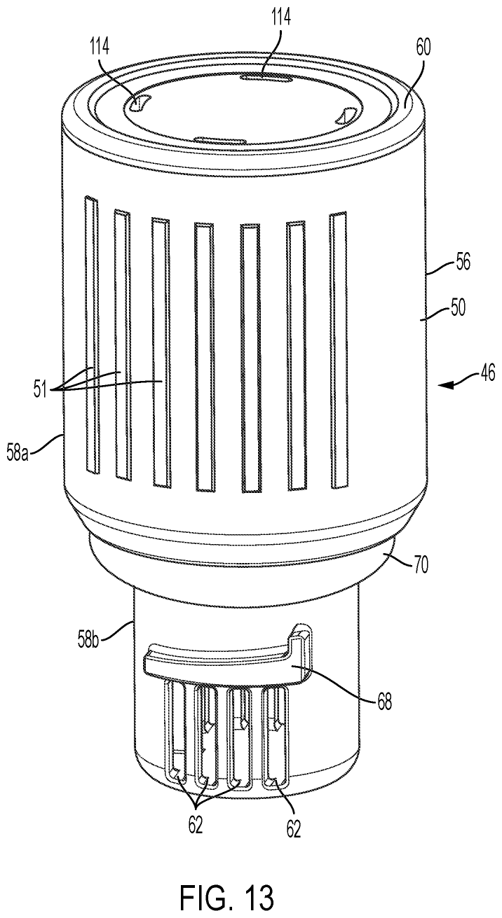

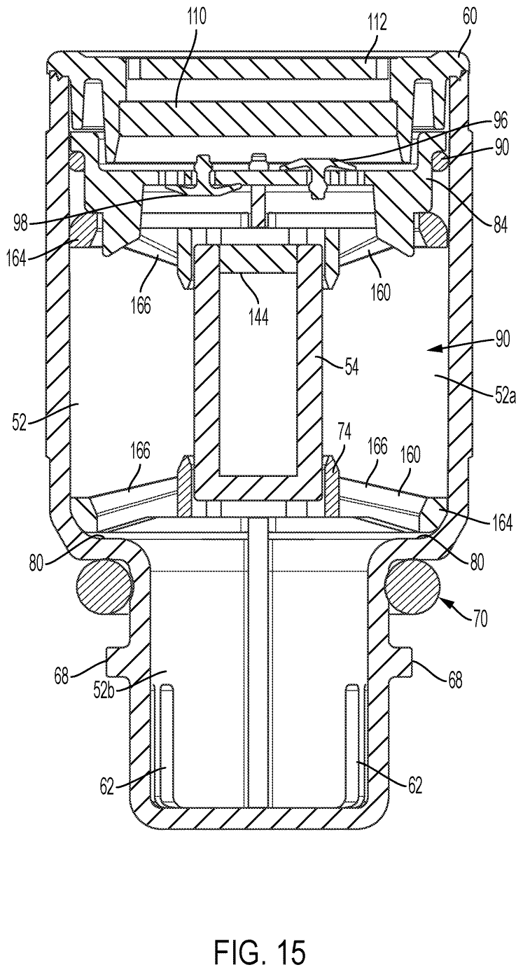

With refence to FIGS. 13, 14 and 15, an alternative embodiment of a recombination device 46 is now described. This embodiment is similar to the prior described embodiment with like elements identified with like reference numbers. As with the device described with reference to FIGS. 3-7, the present recombination device 46 has a cylindrical housing 50 having external ribs 51, a catalyst device 54 supported within, and a cap 84 for sealingly closing the upper end of the internal area 52 to make the recombination device 46 leak (gas) tight. An O-ring 90 is positioned between the outer circular surface of the cap 84 and the inner wall surface 57 of the housing 50 to create the leak tight seal. The cap 84 includes a pressure relief valve 96 and a vacuum relief valve 98 in the same manner as in the previously described embodiment. Positioned above the cap 84 is a circular top cover 60 forming the top of the housing and which includes a flame arrestor 110 as described with the previous embodiment. The catalyst device 54 can be that previously described with refence to FIGS. 8-10 or to FIGS. 11 and 12 (which is illustrated in FIG. 15).

One difference from the prior described recombination device 46 is the opening 62 of the housing 50 that sits inside the gas space 24 of the cell 10. Here the opening 62 comprises two openings on opposing sides of the lower section 58b of the housing, each opening including a series of smaller slotted openings, but which maintains the preferred total opening area as described above for the prior described embodiment. Another difference is the use of two wheel shaped support brackets 160 positioned on opposite ends of the catalyst device 54. The two support brackets 160 are identical in structure but oriented in opposite directions so as to receive an end of the catalyst device 54. The support brackets 160 include an inner cylindrical wall 74 forming a cup like shape having an internal diameter selected to receive an end 130 of the catalyst device 54 within. The inner cylindrical wall 74 can include one or more slots 74a to provide sufficient resiliency for the friction fit. Here, three slots 74a are positioned equally apart from one another around the wall 74 to provide sufficient resiliency where a friction fit is desired. The inner cylindrical wall 74 also includes along its outer edge stop tabs 162 to prevent the catalyst device 54 from moving or falling through the opening defined by the cylindrical wall 74. The support brackets 160 further include an outer rim 164 connected to the inner cylindrical wall by arms 166, and having a diameter to fit within the upper section 58a of the housing 50 and maintain the catalyst device 54 centered within; the outer rim 164 of the lower wheel shaped support bracket 160 rests on a lower internal shoulder 80 (see FIG. 15) within the housing 50, while the upper wheel shaped support bracket 160 supports the cap 84 thereon. The wheel shaped support brackets 160 can be made of the same material as the support brackets 72 of the prior described embodiment, here XAREC® with a 30% glass impregnated filler.

Catalyst devices 54 of the type illustrated above provide flexibility for handling cells 10 of different sizes and with different gassing rates. For example, in one alternative, multiple catalyst devices 54 can be added to the recombination device 46 for the desired gassing rates. This would allow production of standard sized catalyst devices 54, e.g., standard length tubes 120 or cans 170 with a standard amount of catalyst within. Such devices 54 can be combined for desired gassing rates. It is also appreciated that the length and the diameter of the tube 120 can be selected for the desired amount of catalyst within. Some alternative configurations for recombination devices 46 using such catalyst devices 54 are illustrated below with reference to the figures.

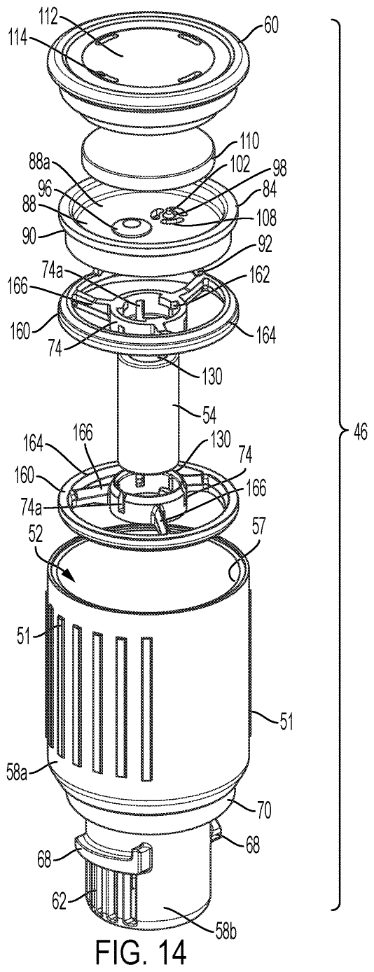

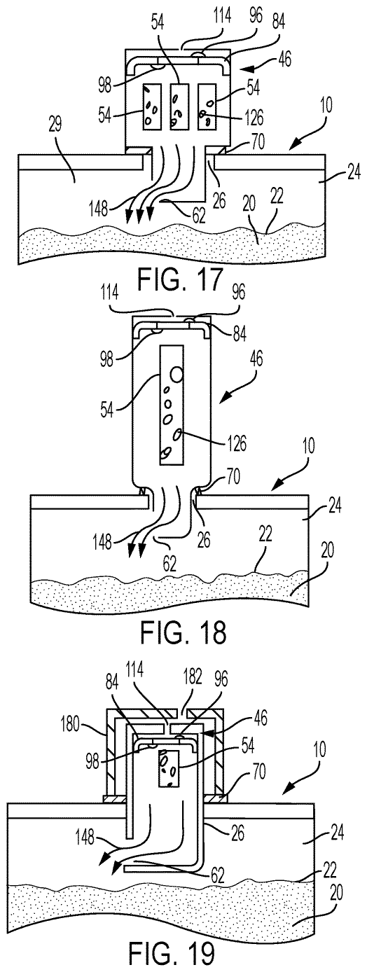

With reference to FIG. 17, a recombination device 46 with multiple catalyst devices 54 is shown attached to a cell 10 in the vent opening 26. The recombination device 46 is similar to those described above with reference to FIGS. 3-7 and FIGS. 13-15 , but configured to support multiple catalyst devices 54 therein using similar catalyst device support members 73 as seen in FIGS. 5 and 14. The arrows 148 in the figure represent the water vapor 45 exiting the recombination device 46. This example highlights the use of multiple catalyst devices 54 allowing the handling of higher rates of gassing without creating excessive heat from the recombination reaction that might be created by simply adding a higher density of catalyst to a single catalyst device 54.

With reference to FIG. 18, a recombination device 46 having a longer catalyst device 54 is illustrated. The recombination device 46 is similar to those described above with reference to FIGS. 3-7 and FIGS. 13-15 , but configured to support a single longer catalyst device 54 therein using a similar catalyst device support member 73 as seen in FIG. 5 or 14. This embodiment can handle higher gassing rates without excessive heat generation due to the recombination reaction.

With reference to FIG. 19, a recombination device 46 is shown having a simpler configuration while still using any of the catalyst devices 54 described above. As seen, this recombination device 46 has a uniform diameter creating a simpler configuration within providing less chance for water vapor to condense and remain within the recombination device 46.

FIG. 19 also shows the use of insulation 180 that can be provided for use in colder environments to help retain the heat generated by the recombination reaction to minimize condensation and maintain the efficiency of the recombination process. In the illustrated embodiment, the insulation 180 is provided in the form of an insulated cap having an opening 182 through which any gases can be exchanged between the atmosphere and the recombination device 54 should the pressure or vacuum relief valves ever activate. The insulation preferably is be made of any suitable material such as a high temperature non-flammable polymer, and which can be the same material as that of the catalyst device housing. Insulation 180 is not limited to the recombination device 46 of FIG. 19 and can be provided with any such device. It also need not be a separate component but can comprise a housing material for the recombination device that has heat transfer properties selected for maintaining the desired temperature within the device 46.

The hygroscopic absorption of the water vapor by the electrolyte 20 is believed to be temperature independent at typical operating environments of flooded cells used in standby service. Initial testing has shown that for battery cells in accordance with the present invention operating in environments at temperatures between 60° F. and 130° F., there is no detectable effect on the operation of the recombination device 46, including the rate of the hygroscopic absorption of the water vapor. Nevertheless, for those operating environments sufficiently cold to potentially have a negative effect on the operation of the recombination device, insulation 180 can be provided as discussed above.

Cell Operation. An example of the operation of a cell 10 in accordance with the present invention is now discussed with reference to FIG. 16. The cell 10 of FIG. 16 is similar to that of FIG. 2, although only partially shown, with like elements being identified with like reference numbers. The recombination device 46 is the same as that shown in FIGS. 3 to 10, again with like elements being identified with like reference numbers.

The cell 10 in FIG. 16 is a stationary flooded cell in standby mode and on float charge. In standby mode, a battery inverter and charger 150 of a known type, receiving electrical power from the regular AC power grid 152 through wires 153, provides AC and/or DC current to the load 154 through electrical wires 156, and DC power to the cell 10 through wires 158. The cell 10 is on float charge, receiving electrical power to maintain its full charge. The charge voltage has a value that is slightly in excess of the value of the open-circuit voltage of the cell 10. As long as it is working, the regular power supply 152 provides the electrical power for the load 154 and for float charging the cell 10. Should the regular power supply 152 fail, the float charging stops and the cell 10 will begin discharging to provide electrical power to the load 154 through the wires 158 to the battery inverter and charger 150, and then through wires 156 without interruption. If the load 154 works on AC current, the battery inverter and charger 150 inverts the DC current from the cell 10 to AC; if the load 154 uses DC current, the DC current from the cell 10 need not be inverted to AC. Once the main power supply 152 is restored, the discharging of the cell stops and float charging of the cell 10 resumes.

The continuous float charging of the cell 10, while on standby and with the cell 10 fully charged, causes the electrolytic decomposition of water in the electrolyte 20 to oxygen and hydrogen gases 44 as shown by bubbles (44). The gases 44 float up through the electrolyte 20 to the gas space 24, where the gases are in fluid communication with the catalyst 48 in the recombination device 46, allowing the exchange of gases therebetween. From the gas space 24, the gases 44 flow upwardly (arrows 146) into the recombination device 46 through the openings 62, and ultimately through the pores 61 in the wall of the catalyst container 119 of the catalyst device 54 where the catalyst recombines the oxygen and hydrogen gases 44 to water vapor 45. With the catalyst device 54 in fluid communication with the electrolyte 20, the water vapor 45 flows out of the tube 120 through the pores 61 (see FIG. 8), down through the recombination device 46 and through the opening 62 into the gas space 24 (arrows 148), where it contacts the electrolyte 20. The electrolyte 20, e.g., sulfuric acid, being highly hygroscopic, attracts and absorbs the water vapor into the liquid electrolyte 20. The large electrolyte surface area 23 of electrolyte 20 in the typical stationary flooded cell 10 is believed to strongly attract and thereby absorb the water vapor 45 almost immediately after the water vapor is produced by the catalyst 48. This quick process helps avoid a buildup of pressure within the cell 10.

Should there be an unexpected event that causes an over pressurization of the cell 10 beyond a predetermined safe limit, the pressure relief valve 96 would open to relieve the pressure, the gases from within the cell 10 passing through the flame arrestor 110 and out the openings 114 (see FIG. 5). Likewise, should there be an unexpected event causing a vacuum within the cell 10 beyond a predetermined safe limit, the vacuum relief valve 98 would open to relieve the vacuum, allowing atmospheric gases 28 to enter. Such events are unexpected and rare in the life of most cells, but relief valves are provided for safety should such events happen.

With sufficient catalyst 48 to handle expected rates of gassing (rate of the electrolytic decomposition of the water to oxygen and hydrogen gases 44) in a flooded cell 10 on float charge, under normal operating conditions with expected rates of gassing, the internal recombination/hygroscopic cycle 55 as seen in FIG. 20 will reach a dynamic equilibrium between the rate of gassing (creation of the oxygen and hydrogen gases 44), the rate of recombination of the oxygen and hydrogen gases 44 to water vapor 45, and the rate of hygroscopic absorption of the water vapor 45 into the electrolyte 20. Put another way, the internal recombination/hygroscopic cycle 55 will reach a point where the rate of recombination of oxygen and hydrogen gases 44 to water vapor 45 is essentially the same as the rate of decomposition of the water in the electrolyte to oxygen hydrogen gases 44 by electrolysis, which will be essentially the same as the rate of hygroscopic absorption of the water vapor 45 into the electrolyte. If the gassing rate changes, for example should the gassing rate change due to a temporary change in the charging voltage, after a short period of time, a new dynamic equilibrium will be reached between the rate of decomposition, the rate of recombination, and the rate of hygroscopic absorption.

The hygroscopy phenomenon for restoring water vapor 45 to the electrolyte 20 is advantageous as compared to other means, such as condensation of the water vapor, which is highly temperature dependent and followed by a flow of liquid water from the recombination device 46 back to the electrolyte 20. Hygroscopy within the cell 10 provides an efficient and fast acting process to return the water to the electrolyte, is less temperature dependent, and one that is believed to be less likely to lose gases and water vapor from the cell 10, such as through excess gassing and over pressurization that would cause the loss of gases through pressure relief venting and thus a loss of water from the cell. Accordingly, it is preferable to maximize the amount of water vapor 45 that is returned to the electrolyte 20 by hygroscopy by configuring the recombination device 46 to return a majority of the water vapor through hygroscopic absorption, i.e., at least 50% of the water vapor, and preferably up to 100% of the water vapor or as close to 100% as possible to obtain the full benefits.

In practice, the full benefits of the present invention can be achieved by ensuring that the recombination/hygroscopic cycle reaches a dynamic equilibrium as quickly as possible, even after changes in the gassing rate, and that 100% of the water vapor or as close to 100% as possible is hygroscopically absorbed by the electrolyte. This will provide a maintenance free battery cell 10 in terms of no measurable water loss over long periods of time, creating, in essence, a maintenance free flooded battery cell.

Certain factors should be considered to reach these benefits. First, a sufficient amount of catalyst 48 should be provided to handle the highest gassing rate expected for the operating conditions of the cell 10. Some oversizing of the amount of catalyst 48 may be desirable to handle unexpected events of gassing above the expected rates. Again, the oxygen and hydrogen gases 44 should be recombined as fast as they are produced to avoid a buildup of the gases within the cell. To enable the catalyst 48 to recombine the oxygen and hydrogen gases at least at the rate that the gases are produced, the catalyst device 54 should be configured to allow the oxygen and hydrogen gases to pass into the device 54 to the catalyst 48 within without restriction, and to allow the water vapor produced therein to exit the catalyst device 54 without restriction. Considerations and examples for allowing such gas and vapor flow were discussed above.

Quick and unrestricted flow of the cell gases 44 from the cell gas space 24 to the catalyst 48, and of the water vapor 45 from the catalyst 48 to the surface 23 of the electrolyte 20 should be provided. This helps to minimize condensation and quickly reach a dynamic equilibrium for the recombination/hygroscopic cycle 55 as soon as possible. One consideration here is to configure the interior 52 (also referred to as the internal area) of the recombination device 46 to provide for such uninhibited (unrestricted) gas flow. The opening 62, or the combined multiple openings 62, should be sized to allow the fluid communication through it in both directions, i.e., oxygen and hydrogen gases flowing from the gas space 24 to the catalyst device 54 for recombination to water vapor 45, and the water vapor flowing from the catalyst device back to the electrolyte 20 for hygroscopic absorption. The faster this process takes place, the less likely water vapor will remain or have time to condense in the recombination device 46, and the more likely that the electrolyte 20 will hygroscopically absorb the water vapor. Preferred opening 62 sizes were described previously.

Another consideration for quick and unrestricted flow of the gases is the volume of the interior 52 of the recombination device 46 (that volume sealed from the atmosphere 28). The smaller the volume, at least in the upper interior 52a, the less area in the recombination device 46 for the gases 44 and water vapor 45 to build up and lag within, leading to quicker recombination and quicker hygroscopic absorption with less chances for condensation of the water vapor. Furthermore, less volume typically means less internal surface area on which the water vapor could condense and interfere with the hygroscopic process. A preferred volume within the interior 52 of the illustrated recombination devices 46 is about 2 cubic inches or less; the volume within the upper interior 52a of the illustrated recombination devices being about 1.5 cubic inches or less, and the volume of the lower interior 52b being about 0.48 cubic inches.

Another factor for quick and unrestricted flow of the gases is the placement of the catalyst device 54. Preferably, it should be as close to the gas space 24 and the electrolyte surface 23 as reasonably possible, taking into account that the catalyst 48 should be protected from the electrolyte 20, which could block the pores 61 through which gases and water vapor flow. This can be achieved as shown in the illustrated embodiments, the catalyst device 54 being positioned in the recombination device 46 at an elevation just above the vent opening 26 and near the openings 62, and protected by the splash shield 64.

In addition to novel apparatuses and devices, the present invention also provides novel methods as now described with further reference to FIG. 20. Attaching the recombination device 46 to the vent opening 26 of a conventional flooded cell 10 as seen in FIG. 16 sealingly closes off the cell gas space 24 from the atmosphere 28, thereby inhibiting any gas flow between the cell 10 and the atmosphere 28 during normal operation of the cell 10. It is seen that for such a stationary flooded cell 10 on standby and on a float charge voltage that is in excess of the value of the open-circuit voltage of the cell 10, the invention provides in one form an internal recombination/hygroscopic cycle of a) gas generation (electrolysis of water to oxygen and hydrogen gases), b) catalytic recombination of the oxygen and hydrogen gases to water vapor, and c) hygroscopic absorption of the water vapor by the electrolyte 20. This method is carried out within the closed system 61 created by the addition of the recombination device 46 attached to the vent opening 26, and which includes within the closed system 61 the electrolyte 20, the gas space 24, the internal area 52 of the recombination device (that area sealed off from the atmosphere and which includes the catalyst device 54 with the catalyst 48 within). The method can further include d) providing fluid communication between the electrolyte 20 and the catalyst 48, which all takes place within the closed system 61. As noted previously, the method and cycle shown in FIG. 20 will continue, possibly for years, until there is an event such as a failure in the main power grid causing the cell 10 to discharge power. By recombining the oxygen and hydrogen gases generated within the cell to water vapor, and absorbing the water vapor back into the electrolyte 20, the electrolyte level 22 can be maintained without the need to add additional water. Under normal operating conditions, this cycle can provide a maintenance free flooded battery cell that loses little or virtually no water over long periods of time, and possibly over the lifetime of the cell 10.

Methods of the present invention are also applicable to retrofitting existing vented flooded cells. Here the method as set forth immediately above would include the step of attaching or providing a recombination device in accordance with the present invention, such as the recombination devices 46 illustrated above, in the vent opening 26 of a traditional prior art cell, including such cells already in service. Here, a cell 10 that was previously vented while in service can be retrofitted with the recombination device 46 in the vent opening, which is simple to do for most cells, to begin to operate in accordance with the present invention and obtain the full benefits thereof.

Whether providing a new cell 10 in accordance with the present invention or retrofitting a conventional prior art cell, the methods of the present invention can take various forms. For example, in another form, a method of the present invention provides: a) float charging a flooded cell on standby at a charge voltage having a value that is in excess of the value of the open circuit voltage of the cell; b) decomposition of the water in the electrolyte to oxygen and hydrogen gases by electrolysis; c) catalytic recombination of the oxygen and hydrogen gases to water vapor; and d) hygroscopic absorption of the water vapor by the electrolyte 20.

Another embodiment of the method where a cell is charged at a charge voltage that has a value in excess of the value of the open-circuit voltage of the cell such that there is there is electrolytic decomposition of water in the electrolyte to hydrogen and oxygen gases would include: a) inhibiting the venting of gases from the flooded cell, the gases including the hydrogen and oxygen gases from decomposition of water in the electrolyte and the water vapor generated by recombining the hydrogen and oxygen gases; b) catalytically recombining the oxygen and hydrogen gases to water vapor by use of a catalyst; c) providing fluid communication between the electrolyte and the catalyst by which the hydrogen and oxygen gases and the catalytically recombined water vapor can flow between the electrolyte and the catalyst; and d) hygroscopically absorbing a majority of said water vapor into the electrolyte. This method can further include step e) continuing steps a through d as long as there is electrolytic decomposition of water in the electrolyte to hydrogen and oxygen gases. Step (a) above can further include the inhibiting of the ingress of gases from the atmosphere into the cell, and can be carried out by adding, e.g., a recombination device 46 in accordance with the present invention.

### Test Examples

To test the effect of the recombination device, special tests were conducted. One of the tests compared cells in accordance with the present invention (hereinafter the “recombination cells”) against standard control cells, that is, prior art flooded cells without a recombination device and which was vented to the atmosphere (hereinafter “control cells”). Other tests described below were of recombination cells only, but which tested the cells at different operating conditions, some of them extreme. All of the test cells were standard off-the-shelf flooded vented cells, the recombination cells having a simple addition of a recombination device 46 in the cell's vent opening in accordance with the present invention, there being no other modifications or changes.

### Example 1

Eight lead acid cells of two different cell capacities were float charged together for a twelve-month period. The eight cells were divided between recombination cells and control cells as follows:
a. Recombination Cells:
   i. Two lead/antimony cells of a 215 Amp hour capacity; and
   ii. Two lead/antimony cells of a 365 Amp hour capacity.
b. Control Cells:
   i. Two lead/antimony cells of a 215 Amp hour capacity; and
   ii. Two lead/antimony cells of a 365 Amp hour capacity.

The eight cells were on a float charge of about 2.25 V for the 12 month period and were maintained at an ambient temperature of about 73° F. Gases vented from each of the cells to the atmosphere were collected in glass graduated cylinders filled with water. The results were impressive.

After 12 months of float charging, there was no measurable amount of gases collected from any of the four recombination cells or any measurable drop in electrolyte level. The control cells, on the other hand, had significant amounts of gas collected and continuous measurable drops in electrolyte level that required repeated filling of water to replenish the lost water from the cells, which loss was in line with expectations. Moreover, upon opening the recombination devices 46 used in the test, although the internal walls of the recombination devices were moist due to the humidity from the water vapor produced within, no perceptible amounts of condensed liquid water was found in areas where condensed liquid water would have collected and accumulated. Such non-existent venting of gases and no measurable drop in electrolyte level in the recombination cells means that no water was lost, while water was lost in the control cells in line with expectations. Furthermore, the lack of any perceptible amounts of condensed liquid water within the recombination devices indicates that most if not all of the water vapor generated within the recombination device was hygroscopically absorbed by the electrolyte.

### Example 2

In this example, recombination cells of the present invention were tested with a higher charging voltage, which causes a higher gassing rate within the cells. Two lead acid cells of two different cell capacities, one a 215 Amp hour capacity and the other a 365 Amp hour capacity, were continuously boost charged at 2.35 volts applied continuously for an eight week period and were maintained at an ambient temperature of about 73° F. Despite the higher rate of gas generation in the two cells due to the higher charging voltage, there was no measurable amount of gases collected from either of the two recombination cells or any measurable drop in electrolyte level. This test demonstrated that even with boost charges, i.e., applying a higher voltage than float charging, which some cell manufacturers recommend for short periods of time after a discharge event, the cells lost no water.

### Example 3

In this example, recombination cells of the present invention were tested with an even higher overcharge voltage, causing even higher gassing rates within the cells. Two lead acid cells of two different cell capacities, one a 215 Amp hour capacity and the other a 365 Amp hour capacity, were continuously charged at 2.6 volts applied continuously for a four week period and were maintained and an ambient temperature of about 73° F. Despite the significantly higher rate of gas generation in the two cells due to the higher voltage, there was no measurable amount of gases collected from either of the two recombination cells or any measurable drop in electrolyte level. This test demonstrated again that even during a significantly higher voltage charging, well above that of normal float charging, the cells lost no water.

### Example 4

In this example, recombination cells of the present invention were tested in a higher temperature setting where condensation catalyst devices would operate much less efficiently or not at all. Two lead acid cells of two different cell capacities, one a 215 Amp hour capacity and the other a 365 Amp hour capacity, were continuously boost charged at 2.35 volts applied continuously for a two week period and were maintained and a temperature of about 120° F. Even at this abnormally high temperature, and applying a voltage higher than that typically used for float charging, there was no measurable amount of gases collected from either of the two recombination cells or any measurable drop in electrolyte level. This test demonstrated that the higher temperature had little effect on the hygroscopic absorption of water vapor by the electrolyte, which would be expected to significantly affect condensation devices even at voltages that would create higher rates of gassing.

In these tests, the catalyst devices 54 within the recombination devices 46 were able to handle all the gases produced at the various rates of decomposition of the water without any restrictions or buildup of gases, i.e., the catalyst was able to recombine the oxygen and hydrogen gases 44 to water vapor 45 at least at the same rate that the gases 44 were produced, which water vapor 45 was then absorbed into the electrolyte 20. While it is possible that some very small amount of water vapor condensed to liquid water, it is believed that about 100 percent or very close to 100% of the water vapor was hygroscopically absorbed into the electrolyte 20.

It is appreciated that the present invention provides methods for a maintenance free flooded cell that requires little if any water over long periods of time. The present invention also provided devices and sub combinations of devices for carrying the inventive method. The present invention also provides for the retrofitting or modification of stationary flooded cells that are currently in use to eliminate most if not all of the watering maintenance. The present invention also provides for the construction of new cells in accordance with the invention.

It is understood that the above identified arrangements are merely illustrative of the many possible specific embodiments which represent applications of the present invention. Numerous and varied other arrangements can readily be device in accordance with the principles of the invention without departing from the spirit and scope of the invention.

1. A method for charging a flooded cell in standby service, wherein said cell includes a positive electrode and a negative electrode in a spaced relationship from one another, and wherein, during charging of the cell at a charge voltage which has a value in excess of the value of the open-circuit voltage of the fully charged cell, there is electrolytic decomposition of water in the electrolyte to hydrogen and oxygen gases, said method comprising:
a) providing the positive electrode and the negative electrode fully immersed in a hygroscopic material of the liquid electrolyte;
b) inhibiting the venting of gases from the cell, said gases including the hydrogen and oxygen gases and water vapor generated by recombining the hydrogen and oxygen gases;
c) catalytically recombining the oxygen and hydrogen gases to water vapor by use of a catalyst;
d) providing fluid communication between said electrolyte and said catalyst by which said hydrogen and oxygen gases and said catalytically recombined water vapor can flow between said electrolyte and said catalyst; and
e) allowing unrestricted flow of said water vapor to the electrolyte to provide a dynamic equilibrium for a hygroscopic cycle; and
(f) hygroscopically absorbing a majority of said water vapor directly into the electrolyte from an internal atmosphere of the flooded cell.

2. A method according to claim 1, wherein said charging comprises a float charge.

3. A method according to claim 2, wherein said charging comprises a float charge at a continuous voltage of no more than 0.3 volts above an open circuit voltage of the fully charged cell.

4. A method according to claim 1, wherein step d) comprises hygroscopically absorbing at least 75% of said water vapor into the electrolyte.

5. A method according to claim 1, wherein step d) comprises hygroscopically absorbing at least 90% of said water vapor into the electrolyte.

6. A method according to claim 1, wherein step d) comprises hygroscopically absorbing at least 95% of said water vapor into the electrolyte.

7. A method according to claim 1, wherein step d) comprises hygroscopically absorbing at least about 99% of said catalytically converted water vapor into the electrolyte.

8. A method according to claim 2, wherein the fluid communication between said electrolyte and said catalyst is configured so that during the float charging of the cell a state of dynamic equilibrium is reached between the rate of oxygen and hydrogen gases created by the electrolytic decomposition of water and the rate of water vapor hygroscopically absorbed in step d).

9. A method according to claim 2, wherein the fluid communication between said electrolyte and said catalyst is configured so that during the float charging of the cell a state of dynamic equilibrium is reached between the rate of water vapor produced in step b) and the rate of water vapor hygroscopically absorbed in step d).

10. A method according to claim 1, wherein step c) comprises providing fluid communication between the catalyst and a majority of a surface area of the electrolyte.

11. A method according to claim 1, wherein step c) comprises providing fluid communication between the catalyst and at least 95% of a surface area of the electrolyte.

12. A method according to claim 1, wherein step c) comprises providing fluid communication between the catalyst and at least 98% of a surface area of the electrolyte.

13. A method according to claim 1, wherein said cell is a lead-acid cell having an electrolyte comprising sulfuric acid.

14. A method according to claim 1, wherein step a) further includes inhibiting the ingress of gases from the environment into the cell.

15. In a method for charging a flooded lead-acid cell at a charge voltage which has a value that is in excess of the value of the open-circuit voltage of the cell, said cell including, in spaced relationship, a positive electrode and a negative electrode, and a liquid electrolyte comprising a hygroscopic material in which the positive electrode and the negative electrode are immersed, wherein, during said charging of the cell, there is a loss of water from the electrolyte through electrolytic decomposition of the water creating hydrogen and oxygen gases that vent from the cell to the surrounding atmosphere, the improvement comprising;
minimizing the loss of water from the cell by inhibiting the venting from the cell of the hydrogen and oxygen gases;
catalytically converting the oxygen and hydrogen gases to water vapor;
providing fluid communication between said catalyst and said electrolyte by which said hydrogen and oxygen gases can flow to said catalyst and said catalytically converted water vapor can flow to said electrolyte;
allowing unrestricted flow of said water vapor to the electrolyte to provide a dynamic equilibrium for a hygroscopic cycle; and
hygroscopically absorbing a majority of said catalytically converted water vapor directly into the electrolyte from an internal atmosphere of the flooded lead-acid cell.

16. The method according to claim 1, wherein the method is carried out by a recombination device comprising a housing, a catalyst disposed within said housing, a mount for sealingly attaching said recombination device to said cell, and which device is configured to provide for the fluid communication of the oxygen and hydrogen gases and the water vapor between said catalyst and said electrolyte within said battery cell, and to inhibit the venting of the oxygen and hydrogen gases and the water vapor to the atmosphere.

17. The method according to claim 16, wherein said recombination device includes a pressure relief valve configured to vent gases from the cell to the atmosphere at a pressure greater than 0 psi relative to atmospheric pressure.

18.-42. (canceled)

43. A method of operating a flooded electrolyte battery cell used in standby service to prevent the loss of water, the method comprising:
a) float charging the cell while on standby with a continuous charge at a constant charge voltage that has a value in excess of the value of the open-circuit voltage of the cell;
b) electrolytically decomposing water in a liquid electrolyte to oxygen and hydrogen gases, said liquid electrolyte including a hygroscopic material;
c) catalytically recombining the oxygen and hydrogen gases to water vapor by use of a catalyst;
d) inhibiting venting of said oxygen and hydrogen gases and said water vapor from the cell;
e) providing fluid communication between the catalyst and the electrolyte for the oxygen and hydrogen gases and water vapor;
f) allowing unrestricted flow of said water vapor to the electrolyte to provide a dynamic equilibrium for a hygroscopic cycle; and
g) hygroscopically absorbing a majority of the water vapor of step c) directly into the electrolyte from an internal atmosphere of the flooded electrolyte battery cell.

44. A method according to claim 43, wherein step c) is carried out by use of a catalyst configured to recombine the oxygen and hydrogen gases into water vapor that is returned to the electrolyte in step f) at a rate at least that of the rate of decomposition of the water in step b).

45. The method according to claim 43, wherein steps b) through f) take place continuously during step a).

46. The method according to claim 43, wherein steps c) through e) are carried out by a recombination device comprising:
a housing providing a leak tight interior when the recombination device is attached to the flooded electrolyte battery cell;
a catalyst disposed within said leak tight interior, said catalyst capable of combining oxygen and hydrogen gases to form water vapor;
a mount for sealingly attaching the recombination device to the vent opening of the flooded electrolyte battery cell; and
wherein the housing has an opening positioned to be in fluid communication with the gas space of the flooded electrolyte battery cell through the vent opening when the recombination device is attached to the flooded electrolyte battery cell to allow fluid communication between the catalyst and the electrolyte.

47. The method according to claim 43, wherein step f) comprises hygroscopically absorbing at least 90 percent of the water vapor of step c) into the electrolyte.

48. The method according to claim 43, wherein step f) comprises hygroscopically absorbing at least 95 percent of the water vapor of step c) into the electrolyte.

49. The method according to claim 43, wherein step f) comprises hygroscopically absorbing at least 98 percent of the water vapor of step c) into the electrolyte.

50. The method according to claim 51, wherein step f) comprises hygroscopically absorbing about 100 percent of the water vapor of step c) into the electrolyte.

51. The method according to claim 43, wherein the fluid communication between said electrolyte and said catalyst is configured so that during step (a) a state of dynamic equilibrium is reached between the rate of oxygen and hydrogen gases created by the electrolytic decomposition of water and the rate of water vapor hygroscopically absorbed in step (f).

52. The method according to claim 43, further comprising: during the float charging of the cell, reaching a state of dynamic equilibrium between the rate of water vapor produced in step b) and the rate of water vapor hygroscopically absorbed in step d).

53. The method according to claim 43, wherein said method is carried out with
a battery cell comprising:
a container having a vent opening therein;
a liquid electrolyte comprising a hygroscopic material within said container;
a gas space in which oxygen and hydrogen gases generated by electrolysis of water from within the cell collects, said vent opening being in fluid communication with said gas space;
at least one positive plate immersed in said electrolyte; and
at least one negative plate immersed in said electrolyte; and
a recombination device sealingly connected to said vent opening to be in fluid communication with said gas space, the recombination device comprising:
a housing providing a leak tight interior when the recombination device is attached to the battery cell;
a catalyst disposed within said leak tight interior, said catalyst capable of combining oxygen and hydrogen gases to form water vapor; and
a mount for sealingly attaching the recombination device to the vent opening of the battery cell; and
wherein the housing has an opening positioned to be in fluid communication with the gas space of the battery cell through the vent opening when the recombination device is attached to the battery cell to allow fluid communication between the catalyst and the electrolyte.

54.-66. (canceled)

67. The method according to claim 1, wherein the dynamic equilibrium occurs between a rate of creation of oxygen and hydrogen gases, a rate of recombination of oxygen and hydrogen gases to water vapor, and a rate of hygroscopic absorption of the water vapor into the electrolyte.
